(19) United States
(12) Patent Application Publication
(10) Pub. No.: US 2010/0166244 A1
(43) Pub. Date: Jul. 1, 2010

(54) MICROPHONE AND MICROPHONE HEAD

(75) Inventor: Dirk Hackbarth, Hannover (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sennheiser Electronic GmbH & Co. KG, Wedemark (DE)

(21) Appl. No.: 12/646,022

(22) Filed: Dec. 23, 2009

(30) Foreign Application Priority Data
Dec. 29, 2008 (DE) 20 2008 017170.9

(51) Int. Cl. H04R 9/08

(52) U.S. Cl. 381/361

(57) ABSTRACT

A microphone includes a microphone head having a chassis, a circuit board and a microphone cage. The chassis may be fixed in the microphone cage, and the circuit board may be fixed between the chassis and the microphone cage.

The present invention concerns a microphone and a microphone head.

Microphones such as for example hand microphones typically have a microphone cage which can be removed or unscrewed. Such a microphone cage serves inter alia to receive the microphone capsule. Thus for example a defective microphone capsule can be replaced and the hand microphone can continue to be used.

An object of the present invention is to provide a microphone which is more reliable. That object is attained by a microphone as set forth in claim 1 and by a microphone head as set forth in claim 5.

Thus there is provided a microphone having a microphone head. The microphone head has a chassis, a circuit board and a microphone cage. The chassis can be fixed in the microphone cage and the circuit board can be fixed between the chassis and the microphone cage.

According to an aspect of the present invention the chassis has a screwthread to be screwed in the microphone cage. In that way the chassis and the microphone cage can be easily fixed together and to each other.

According to a further aspect of the present invention the circuit board has a first side and a second side. Electric and/or electronic components are provided on the second side. A ground surface is provided on the first side.

According to a further aspect of the present invention the ground surface 53 is provided in the form of a ring at the edge of the circuit board.

The circuit board is fitted with the second side, that is to say with the ground surface, into the microphone cage and thereafter the chassis is screwed to the microphone cage.

That thus makes it possible to provide for a secure fit for the circuit board in the microphone head.

The invention also concerns a microphone head for a microphone. The microphone head has a chassis, a circuit board and a microphone cage. The chassis can be fixed in the microphone cage. The circuit board can be fixed between the chassis and the microphone cage.

The invention is based on the realisation that, in conventional microphones, there can be a relative movement between the microphone cage and the contacting means of the microphone capsule. In addition bending moments can be exerted on a circuit board of a microphone capsule or a microphone head.

The microphone according to the invention avoids the relative movements between the microphone cage and the circuit board of the microphone head.

In addition the circuit board can be concentrically positioned by the chassis of the microphone head. In that case the chassis can have a male screwthread to be screwed into a microphone cage. In that case for example a required circuit board can be screwed between the chassis and the microphone cage and thus secured.

The circuit board can optionally have a ground surface co-operating with the microphone cage in such a way that a ground connection is made possible.

Further configurations of the invention are subject-matter of the appendant claims.

Advantages and embodiments by way of example of the invention are described in greater detail hereinafter with reference to the drawing.

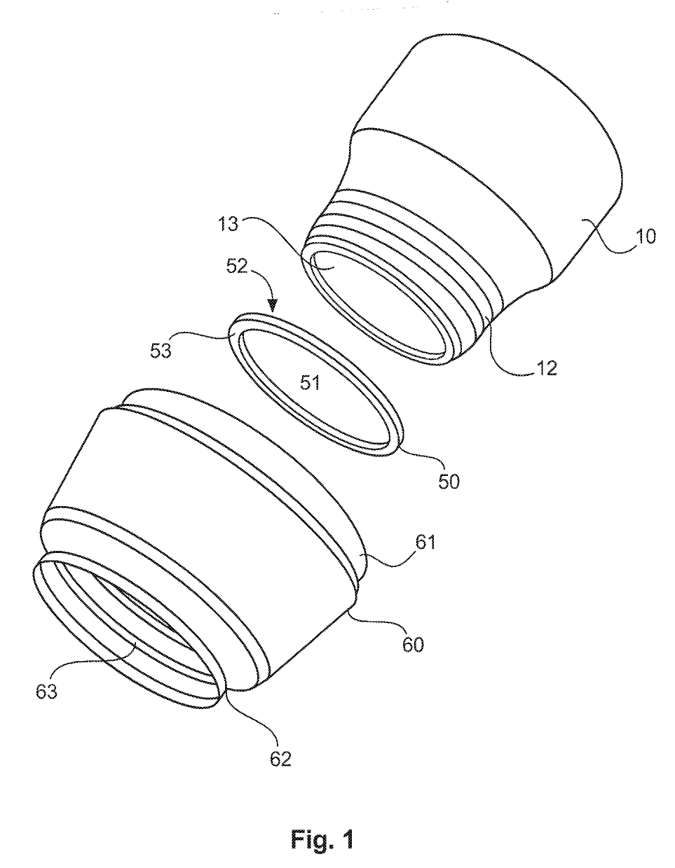

FIG. 1 shows a diagrammatic view of a microphone head in a first embodiment, and

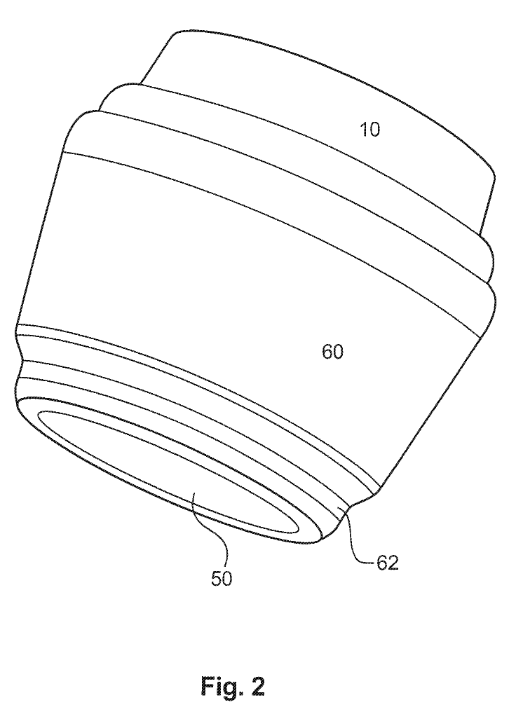

FIG. 2 shows a perspective view of a microphone cage in the first embodiment.

FIG. 1 shows a diagrammatic view of a microphone head in accordance with a first embodiment. In this case a microphone head has a chassis 10 with a male screwthread 12 at the underside. There is also a (round) printed circuit board 50 having a ground surface 53 at the outer periphery. The circuit board 50 has a first lower surface or side 51 and a second upper surface or side 52. Electric and/or electronic components can be provided on the second side 52. In contrast the ground surface 53 can be provided at the lower side 51. The microphone head can also have a microphone cage 60 having a first end 61 and a second end 62. The first end 61 serves to receive the circuit board 50 and the chassis and can be screwed to the screwthread 12.

A female screwthread 63 can be provided at the second end 62 of the cage and can serve to screw the cage to a hand transmitter.

FIG. 2 shows a perspective view of a part of a microphone head in accordance with the first embodiment. In particular the chassis 10, the circuit board 50 and the microphone cage 60 are shown screwed together. That can be effected in particular by the screwthread 12 being screwed in the cage 60, in which case the circuit board 50 is arranged between the chassis 10 and the cage 60 and is thus screwed together and accordingly fixedly secured between the chassis and the cage.

Preferably the chassis 10, the circuit board 50 and the cage 60 are of a substantially round configuration so as to permit concentric positioning of the circuit board by the chassis. In particular that can be achieved by the provision of the male screwthread 12 at the chassis 10. Preferably the circuit board 50 is fitted with the first side 51 with the ground surface 53 leading into the cage 60. The chassis 10 and the cage 60 are then screwed together so that it is possible to provide a secure fit for the circuit board with a ground connection to the microphone cage 60.

1. A microphone comprising:
a microphone head having a chassis, a circuit board and a microphone cage, wherein the chassis can be fixed in the microphone cage and wherein the circuit board is fixed between the chassis and the microphone cage.

2. A microphone as set forth in claim 1 wherein the chassis has a screwthread for screwing in the microphone cage.

3. A microphone as set forth in claim 1 wherein the circuit board has a first side and a second side, wherein electric and/or electronic components are provided on the second side, and
wherein a ground surface is provided on the first side.

4. A microphone as set forth in claim 3 wherein the ground surface is in the form of a ring at the edge of the circuit board.

5. A microphone head for a microphone comprising
a chassis, a circuit board and a microphone cage,
wherein the chassis can be fixed in the microphone cage and the circuit board can be fixed between the chassis and the microphone cage.
